(19) United States
(12) Patent Application Publication
(10) Pub. No.: US 2003/0050858 A1
(43) Pub. Date: Mar. 13, 2003

(54) Method for ordering production goods

(75) Inventor: Gernot Rossi, Simmelsdorf (DE)

Correspondence Address: Henry M. Feiereisen, Suite 3220, 350 Fifth Avenue, New York, NY, 10118, US

(73) Assignee: SIEMENS AKTIENGESELLSCHAFT, Munchen (DE)

(21) Appl. No.: 10/236,460

(22) Filed: Sep. 6, 2002

(30) Foreign Application Priority Data
Sep. 7, 2001 (DE) 101 44 066.9
Aug. 8, 2002 (DE) 102 36 443.5

(51) Int. Cl. G06F 17/60

(52) U.S. Cl. 705/26

(57) ABSTRACT

In a method for ordering at least one item, an automation component executes this order. Costs are hereby lowered and efficiency of the automation component and/or industrial machines can be increased.

### CROSS-REFERENCES TO RELATED APPLICATIONS

This application claims the priority of German Patent Applications, Ser. Nos. 101 44 066.9, filed Sep. 7, 2001, and 102 36 443.5, filed Aug. 8, 2002, pursuant to 35 U.S.C. 119(a)-(d), the subject matter of which is incorporated herein by reference.

### BACKGROUND OF THE INVENTION

The present invention relates to a method for ordering an item, such as, e.g., hardware, software and/or a service.

Typically, a customer or contractor (hereinafter called generally “customer”) requires personnel to execute an order for an item for an automation component and/or industrial machine, e.g. a production machine or power tool. The use of personnel to place the order for software, hardware and/or service requires expertise as far as handling of the order is concerned and expertise about the production item involved. Execution of the purchase order is thus very time-consuming for the customer because of the requirement to obtain information about the component or part to be ordered, about the associated order number, and about the person to whom the order is to be directed. Also, the supplier of the goods uses personnel to handle the purchase order. In particular, when an order for software is involved, it is oftentimes required to ship software on data carriers as hardware to the customer. These actions are very time-consuming and cost-intensive. Moreover, there is often an element of uncertainty as to whether the correct production item has actually been ordered. Although using more qualified or trained personnel may minimize this element of uncertainty to handle the order, such personnel greatly increases the cost factor.

It would therefore be desirable and advantageous to provide an improved method for ordering production goods to obviate prior art shortcomings.

### SUMMARY OF THE INVENTION

According to one aspect of the present invention, in a method for ordering production goods at least one automation component is provided for ordering at least one item.

To ensure clarity, it is necessary to establish the definition of several important terms and expressions that will be used throughout this disclosure. The term “automation component” or “automation equipment” relates to a device which may be separate from or form part of an industrial machine. Automation components involved here include, for example, numerical controls (NC, CNC (computer numerical controls)), converters, automatic controls).

The present invention resolves prior art problems by so constructing automation components, industrial machines and/or assemblies to execute orders without personnel or with personnel for only limited checking role. The order is directed to a supplier of production goods. The size of the order may be limited by monetary considerations or by the type of the order. Orders may involve, for example, hardware such as wearing parts, e.g., fans or batteries, predefined system configurations of an assembly or an industrial machine, which are activated by software, or updates of hardware versions or software versions. For example, it is also possible to order a software activation of software functions. In addition, there is also the possibility to order services, relating to maintenance works or optimization of a system, assembly or the like. Optimization may be carried out in regular intervals, e.g. triggered by a running time meter or following a recognizable qualitative deterioration of the automation component and/or industrial machine.

One or more orders placed by the industrial machine and/or automation component of the industrial machine can be extended, optionally, also for service applications. Payment for an ordered item may, e.g., be realized by debiting an account or providing credit. A central data protection of an assembly, industrial machine and/or automation component may be provided to enhance the system security, which is responsible for various customers and/or only one customer. An automated data protection from a central station may be implemented through initiation by the central station in regular intervals, or triggered by the automation component, which affords the protection. Central stations, which are connected with de-centralized automation components, are also capable to manage and/or to store automatically generated final messages, service messages and information for system expansion. Examples for a transmission medium for the information transfer include the Internet or other data networks or data communications such as local area networks (LAN) or mobile communication.

According to another feature of the present invention, the automation component can ascertain a need for an item and can place a respective order. Advantageously, the automation component assumes the task to execute orders, thereby reducing costs and enhancing the usefulness of automation components because the ordering process and shipment can be executed more rapidly and/or more reliable.

For example, the control unit of an assembly, a machine and/or automation component may be informed by the manufacturer about the availability of new software. When authorized to order software updates, the automation component places the order for the software and/or updated versions.

According to another feature of the present invention, the automation component transmits the order via an electronic medium for data transfer to a supplier, and the supplier executes the order. The supplier is in a position to identify the automation component that generated the order. After identification, it is determined whether the automation component is authorized to generate the order and which payment method has been agreed upon with respect to this automation component. If the determination affirms the correctness of the order by the automation component, the supplier of the goods then executes the order. Production goods involved here include hardware, software and/or services.

According to another feature of the present invention, the automation component may query for an item in a market in which a supply and demand for that item exists, by communicating an order to the market and having a supplier satisfy the demand and execute the order. Hereby, the order communicated to the market is tied with an establishment of the maximum price. Thus, the automation component also triggers a competitive bidding by suppliers to find the cheapest supplier for the item at hand and to place this order with this supplier. Suitably, the market involved here is an electronic trading center.

According to another feature of the present invention, the automation component may include offers for the production goods from at least two suppliers, so that the automation component is in a position to select the least expensive offer and place an order. The automation component has at its disposal a budget for payment of the order. This budget may be, for example, at least one software code which is based upon a certain amount of monies. When the software code is sent to the supplier, the deposited monies assigned to this code are retrieved. Advantageously, the automation component may also be registered with a particular supplier for clearance of at least one or more types of order forms to buy on terms. The term “to buy on terms” is an economical expression and corresponds in effect to an establishment of a line of credit. Another variation involves the generation of orders by at least one automation component until a budget deposited with the supplier is overdrawn.

According to another feature of the present invention, the automation component may include an authorization for the ordering process. In this way, each automation component is parametrizable individually with respect to its assigned competence to execute orders. An example of a parametering option involves an inspection of the order of the automation component by a living person.

According to another feature of the present invention, the automation component may recognize the need for an item. The software for the automation component may be written in such a way that the automation component is instructed to periodically query the manufacturer of the automation component for the availability of updated versions for the software and to place an order if affirmative. Suitably, the order is linked to an automatic installation and retention of existing settings.

According to another feature of the present invention, the automation component is linked by data connection to another automation component such as to receive a purchasing requisition for an item from the other automation component. An automation component may hereby be so configured as to ascertain the demand of other automation components connected thereto. Suitably, an automation component may be so constructed as to be able to receive purchasing requisitions of other automation components or to determine a demand for goods of other automation components and to place orders. In particular when power tools and/or production machines, which are automation components and/or also include them, are involved, great versatility of this industrial machine is demanded. With the assistance of the self-ordering feature of automation components, e.g. via internet-type means and/or means for data transfer, such as telecommunication devices, the usefulness of the industrial machines is enhanced.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1a is a schematic block diagram of a conventional ordering process for purchase of production goods;

FIG. 1b is a schematic block diagram of one embodiment of an ordering process for purchase of production goods in accordance with the present invention;

FIG. 2a is a schematic block diagram of a conventional example of an ordering process for purchase of production goods to equip a machine with production goods; and

FIG. 2b is a schematic block diagram of another embodiment of an ordering process for purchase of production goods in accordance with the present invention to equip a machine with production goods.

### DETAILED DESCRIPTION OF PREFERRED EMBODIMENTS

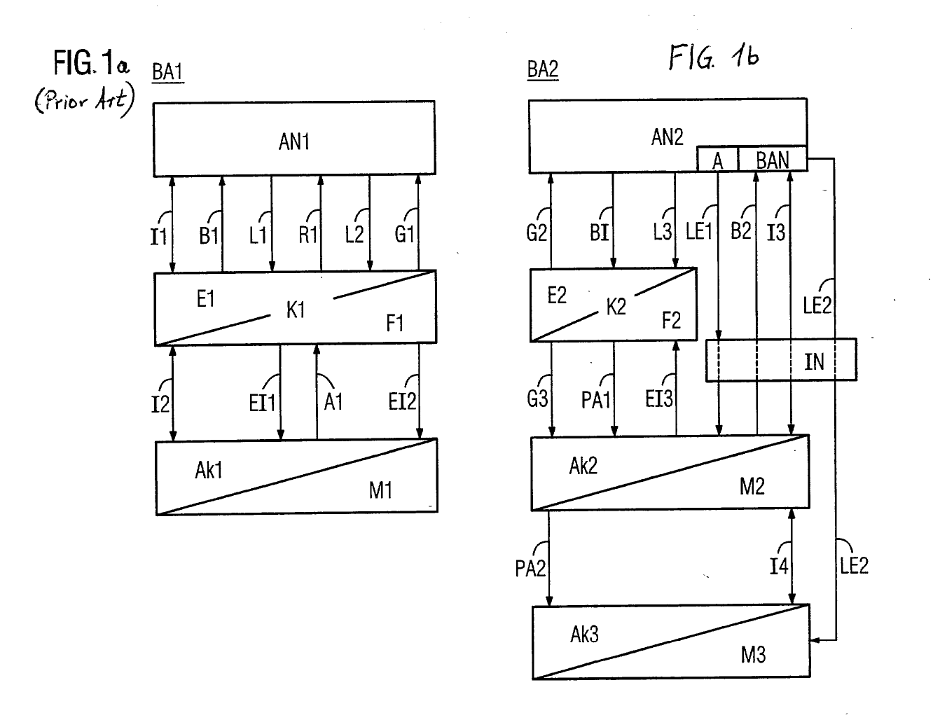

Turning now to the drawing, and in particular to FIG. 1a, there is shown a schematic block diagram of a conventional ordering process BA1 for purchase of production goods. A customer K1, having an automation component AK1 and/or an industrial machine M1, is in contact with a supplier AN1, who offers goods for the automation component AK1 and/or industrial machine M1. The automation component AK1 may hereby be a unit separate from the industrial machine M1 or form at least part thereof. Through exchange of information I1 with the supplier AN1, the customer K1 learns about the offer from the supplier AN1. The information involves hereby printed material such as catalogs or brochures, or telephone conversations. When the customer K1 is a large entity, it may have a purchasing department E1 as contact partner for the supplier AN1. The customer K1 has information I2 about his or her automation component AK1 and/or the industrial machine M1. In particular when larger entities are involved, this information is collected in a production department F1. As a consequence, there exists an interface at the customer K1 between at least two departments, that is the purchasing department E1 and the production department F1. The existence of such an interface may lead to communication problems as far as transfer of information is concerned, e.g., an order for a spare part with a particular order number or a particular updated software version. When information is incorrectly transmitted between the departments E1 and F1 of the customer, wrong parts will be ordered. A reversal of the transaction is hereby time-consuming and cost-intensive.

In trimmed down businesses, such interface problems between departments of the customer K1 are only encountered to a limited degree. In the event, the automation component AK1 reports, e.g., an error, and the customer K1 notes that an order has to be placed with the supplier AN1 for a spare part, an information I1 has to be procured about the order number assigned to the spare part. The customer K1 is aware about the stock of the supplier AN1 through information I1 to enable a selection of the spare part for a price according to information I1. The customer K1 places an order with the supplier AN1. The supplier AN1 delivers the purchased item to the customer K1 via shipment L1. The item is installed by the customer K1 in the automation component AK1 and/or industrial machine M1, as indicated by arrow EI1. Payment of the acquired item is realized by payment transaction G1. In the event, the ordered item is a hardware product, a tangible delivery is required as opposed to a purchase of software or software update. Still, a purchase of software or software update involves a tangible shipment via data carriers because a different way to handle the shipment of the software is oftentimes not possible for payment reasons.

When a wrong item has been ordered by mistake, whether hardware or software, the item has to be removed from the automation component AK1 and/or industrial machine M1, as indicated by arrow A1. The item is returned by return shipment to the supplier AN1. By way of a second shipment L2, the supplier AN1 delivers the correct item to the customer K1 for subsequent second assembly EI2 into the automation component AK1 or industrial machine M1. This ordering process B1 has many interfaces that require acquisition and transfer of data and information. As a consequence, errors in communication, e.g. typographic errors or error information through use of old catalogs, occur frequently. The conventional ordering process BA1 is thus complex, laborious, prone to errors and/or cost-intensive.

Turning now to FIG. 1b, there is shown a schematic block diagram of a first embodiment of an ordering process BA2 for purchase of production goods in accordance with the present invention. The ordering process BA2 shows a customer K2 having a purchasing department E2 and a production department F2. Further shown are an automation component AK2 and/or industrial machine M2 as well as an automation component AK3 and/or an industrial machine M3. In accordance with the present invention, a budget is assigned to the automation component AK2 and/or industrial machine M2 for limited and unlimited access by the industrial machine M2 and/or automation component AK2. Assignment of the budget is implemented, for example, by payment transaction G3. This payment transaction G3 provides an instrument of payment for the automation component AK2 and/or industrial machine M2. An example of such an instrument of payment is at least a software code which is commensurate with a particular monetary value and serves as instrument of payment with respect to a supplier AN2 of production goods. Another process for establishment of a budget for the automation component AK2 and/or industrial machine M2 is characterized by payment transaction G2 which involves a transfer of funds from the customer K2 to the supplier AN2, so that the supplier AN2 has at his disposal a budget of funds. In addition, the customer K2 may provide the supplier AN2 with information about which automation component is authorized for placing an order.

Advantageously, a purchase on deferred payment terms may be agreed upon between the customer K2 and the supplier AN2. The customer K2 may generally clear a purchase order by its automation component AK2 and/or industrial machine M2 with the supplier AN2, whereby the automation component AK2 and/or industrial machine M2 identifies itself at the supplier AN2 when the order is placed. The identification process for the automation component AK2 and/or industrial machine M2 is agreed upon between the customer K2 and the supplier AN2. When the automation component AK2 and/or industrial machine M2 determines a need for an item, the purchase order B2 is conveyed directly to the supplier AN2. The order B2 may relate, e.g., to a defective hardware part, whereby the automated ordering process between the automation component AK2 and/or industrial machine M2, on the one hand, and an automated device of the supplier AN2 to accept the order, indicated at BAN, is fool-proof and will not result in incorrect orders, as compared to the conventional ordering process BA1 of FIG. 1. The automation component AK2 itself recognizes the need for an item. The supplier AN2 identifies the automation component AK2 and fills the order B2 by delivering the item via shipment L3 to the customer K2 whose production department F2 then executes the assembly EI3 of the item. In the event, the automation component orders software, the shipment and the assembly are implemented simultaneously, e.g., automatically, via the track, shipment and assembly LE1.

Advantageously, the shipment and assembly is carried out in an automatic way. The Internet IN may hereby serve as communication tool between the automation component AK2 and/or industrial machine M2 and the supplier AN2. As the order receiving station BAN of the supplier AN2 is automated, also the shipment is implemented by an automated device for handling the shipment, as indicated by reference character A. An exchange of information 13 is provided between the automation component AK2 and/or industrial machine M2, and the supplier AN2, including information about, e.g., availability of spare parts, costs of spare parts and/or other production goods. In addition, payment transactions between the supplier AN2 and the automation component AK2 and/or industrial machine M2 can be handled via the information 13. As soon as the automation component AK2 is identified, an order is authorized commensurate with the assigned budget. If the automation component AK2 and/or industrial machine M2 has a software code in accordance with a particular budget as instrument of payment, this code can be transmitted to the supplier AN2. The customer K2 is in a position to parameter its automation component AK2 and/or industrial machine M2 via a parameterization PA1 in a way as to how and to which extent automated ordering processes will be permitted. Upon execution of an automated order, the supplier AN2 sends an order information B1 to the customer K2. The automation component AK2 and/or industrial machine M2 can be proficient enough to also carry out ordering processes for other automation components, such as, e.g., the automation component AK3 and/or industrial machine M3. An exchange of information 14 is provided between the automation component AK2 and AK3 and/or industrial machines, as well as a parameterization and control via track PA2.

An order for the automation component AK3 and/or industrial machine M3 can be executed via the automation component AK2 and/or industrial machine M2. The shipment is implemented, e.g., via the automation component AK2 and/or industrial machine M2 or directly via a separate track for shipment and/or assembly LE3. When shipment of software is involved, the assembly corresponds, e.g., to the installation of the software.

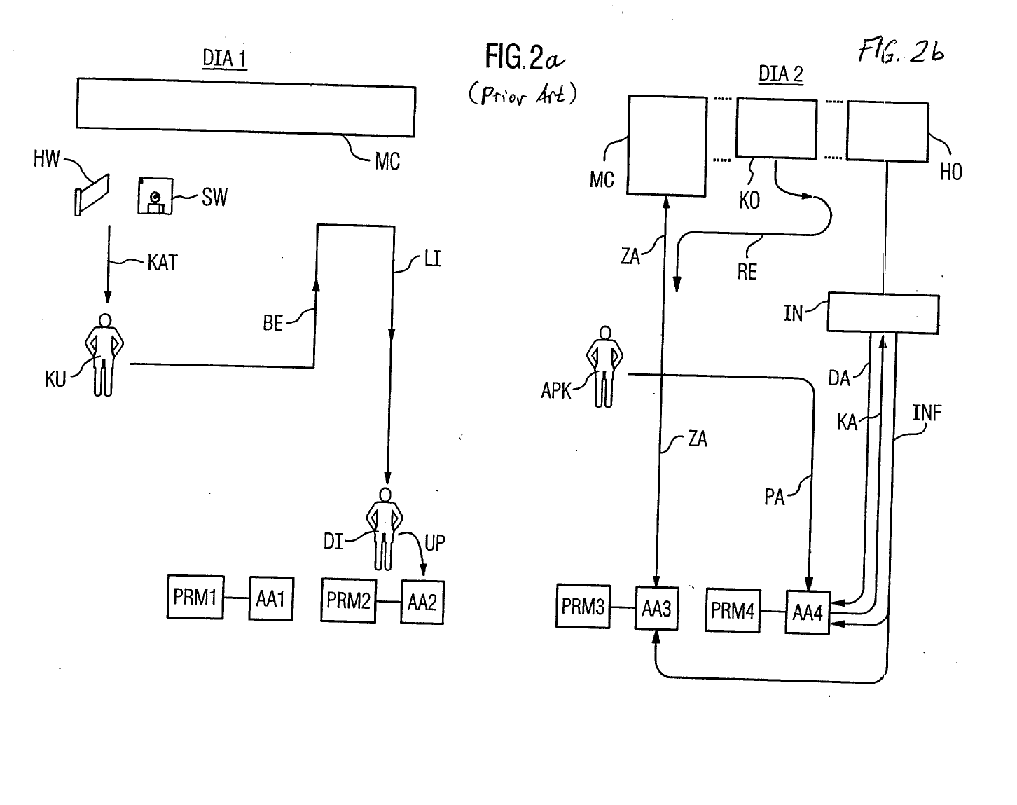

Referring now to FIG. 2a, there is shown a schematic block diagram of a conventional example of a process for equipping a machine with production goods. The term “production goods” is used here in a generic sense and includes hardware HW as well as software SW or service DI. An example for the machine includes a production machine PRM1 or a production machine PRM2. The production machine PRM1 is operatively connected to automation equipment M1, and the production machine PRM2 is operatively connected to automation equipment AA2. A manufacturer MC offers the production goods HW, SW, DI to a potential customer KU. The manufacturer MC may be an entity that delivers to an end customer or, e.g. to an OEM (Original Equipment Manufacturer) customer. For example, a manufacturer of power tools constitutes the OEM for a manufacturer of controls for power tools. Likewise, the role of the customer KU may be an OEM customer or an end customer who receives a power tool from the power tool manufacturer. The manufacturer MC provides the customer KU with information material KAT in the form of, e.g., catalogs or brochures about the production goods HW, SW and/or DI. The customer KU selects herefrom the desired item and places a respective order BE with the manufacturer MC, resulting in a shipment LI of the item for the production machine PRM2 and/or automation equipment AA2. A service provider provides there the service DI, for example the execution of an update UP of a software for the production machine PRM2 and/or automation equipment AA2. At least one person is put at all times in between the machines, i.e. production machines PRM1, PRM2 and associated automation equipments M1, AA2, on the one hand, and the manufacturer MC of production goods HW, SW, DI, on the other hand. This interjects an element of uncertainty into the process which the present invention now contemplates to eliminate.

Referring now to FIG. 2b, there is shown a schematic block diagram of one embodiment of a process DIA2 for equipping a machine with production goods in accordance with the present invention. A manufacturer MC provides production goods for a production machine PRM3 with pertaining automation equipment AA3 and for a production machine PRM4 with pertaining automation equipment AA4. Reference character APK designates an active person who assumes a temporary role as mediator between the manufacturer MC and the production machines PRM3, PRM4 with associated automation equipment M3, M4. In the present non-limiting example, the production machine PRM3 in concert with the automation equipment M3 is authorized by the person APK to communicate with a host HO via the Internet IN. Through such an information link INF, information about software updates or new software versions can be made available for the automation equipment M3. In addition, the information link INF enables a transmission of information about software updates or other software products to the automation equipment AA3. When the person APK authorizes the automation equipment AA3 to place an order with the host HO for purchase of software, the order as well as the shipment is implemented via the information link INF. Payment of the production item, as ordered and received by the automation equipment M3, is based on the payment terms ZA, as agreed upon and established between the manufacturer MC of the person APK and the automation equipment M3. After shipment of the item, e.g., account KO of the customer, who operates the production machines PRM3, PRM 4, is debited. An invoice RE is generated, e.g. by E-Mail, and provides information about the invoice RE itself as well as about the new balance of account KO. The invoice RE is presented, e.g., to the person APK. As far as the automation equipment AA3 is concerned, the ordering process for production goods, regardless whether hardware, software or services are involved, and, possibly also shipment of software or service, are fully automated after establishment of the respective functions, and is realized without any contribution by a person.

The process may also be configured in such a manner that a production machine PRM4 together with the respective automation equipment AA4 is parameterized by a parameterization through the person APK in a way that an order can be prepared, however its execution is, optionally, dependent on the approval by the person APK. Like the automation equipment AA3, the automation equipment M4 receives via the Internet IN and host HO, which, e.g., serves as update management, information via the information link INF. In view of this information and the approval by the person APK, a purchase KA is triggered, i.e., an order for a respective item is placed. The information and data DA about the purchase, which may contain also an invoice, are automatically transmitted to the automation equipment M4 in the case of the automation equipment M4. The person APK at the automation equipment AA4 may inspect the invoiced amount or the balance of an account KO debited by the order. The manufacturer MC is able to provide accounts KO or hosts HO for management of updates or similar functions. Of course, it is also possible that the intermediate trade provides these functions.

The process DIA2 for ordering production goods, in accordance with the present invention, can be carried out automatically, with or without an active person APK, by a machine which may include the production machine PRM3, PRM4 itself and/or an automation equipment M3, AA4. Payment of the order may be executed automatically by debiting an account KO, or by an exchange of instruments of value from the automation equipment to the manufacturer MC or host HO, or via the normal generation and payment of an invoice, or via other forms of settlement of arrears as a result of an acquisition of production goods.

Through suitable configuration, an automation component, i.e. automation equipment M3, M4, can be used to execute by itself an order of production goods. As a consequence, downtimes in case of an error condition can be reduced and a machine can be serviced better and more detailed since actual software errors can be eliminated through automatic software updates. When a machine, whether a power tool, a production machine, or manipulator, should be retrofitted, its automation component is able to order all required production goods rapidly and reliably so that downtimes can be reduced in a production. The orders can be satisfied without errors, e.g. through typographic errors.

While the invention has been illustrated and described in connection with preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for ordering production goods, comprising the step of providing at least one automation component for ordering at least one item.

2. The method of claim 1, and further comprising the step of configuring the automation component to ascertain a need for the item.

3. The method of claim 1, wherein the item is hardware.

4. The method of claim 1, wherein the production item is software.

5. The method of claim 1, wherein the production item is a service.

6. The method of claim 1, wherein the automation component communicates the order via an electronic medium for data transfer to a supplier, and further comprising the step of execution of the order by the supplier.

7. The method of claim 1, wherein the automation component queries for a item in a market in which a supply and demand for the item exists, by communicating an order to the market, and having a supplier satisfy the demand and execute the order.

8. The method of claim 1, wherein the automation component procures offers for the item from at least two suppliers, and further comprising the step of having the automation component select one offer from the offers.

9. The method of claim 1, wherein the automation component has at its disposal a budget for payment of the order.

10. The method of claim 1, wherein the automation component includes an authorization for the order.

11. The method of claim 1, and further comprising the step of implementing the order by a software which is manipulatable by a user through at least one of parameterization process and programming process.

12. The method of claim 11, wherein the software is modifiable by at least one of authorization process and ordering process.

13. The method of claim 1, and further comprising the step of having a user inspect the order.

14. The method of claim 1, wherein the automation component is configured to recognize by itself a need for the item.

15. The method of claim 1, and further comprising the step of transmitting a purchasing requisition from another automation component to the automation component, wherein the other automation component is linked to the automation component by data connection.

16. The method of claim 1, wherein the automation component ascertains a demand of at least one other automation component linked to the automation component by data connection.

17. The method of claim 1, wherein the automation component is at least part of a power tool.

18. The method of claim 1, wherein the automation component is at least part of a production machine.

19. The method of claim 9, wherein the budget is a software code which is commensurate with an amount of monies.

20. The method of claim 6, wherein the automation component is registered by the supplier to establish a line of credit.

21. The method of claim 6, wherein the automation component is in the possession of a customer who deposits a budget with the supplier so that the automation component is able to place orders until the budget is overdrawn.

22. The method of claim 4, wherein the automation component is configured to periodically query the supplier for the availability of updated versions of the software, and, if affirmative, to place an order.

23. The method of claim 22, wherein the order is linked to an automatic software installation and retention of existing settings.
